(19) United States
(12) Patent Application Publication
(10) Pub. No.: US 2013/0251622 A1
(43) Pub. Date: Sep. 26, 2013

(54) ENHANCED OXYGEN GENERATION FROM MOLTEN SALT

(71) Applicants: Debangshu Guha, Kingsport, TN (US); James P. Seaba, Calgary (CA)

(72) Inventors: Debangshu Guha, Kingsport, TN (US); James P. Seaba, Calgary (CA)

(73) Assignee: PHILLIPS 66 COMPANY, Houston, TX (US)

(21) Appl. No.: 13/615,715

(22) Filed: Sep. 14, 2012

Related U.S. Application Data
(60) Provisional application No. 61/577,260, filed on Dec. 19, 2011.

(51) Int. Cl. C01B 13/02

(52) U.S. Cl. CPC C01B 13/0296
USPC 423/579

(57) ABSTRACT

Methods and systems are provided for producing oxygen through pressure and temperature swing absorption using molten salt under non-corrosive process conditions. The process relies on the ability of the molten salt mixture to selectively absorb oxygen from a gas mixture (e.g. from air) by means of an oxidation reaction under certain process conditions, and subsequently desorb the oxygen from the molten salt mixture by means of the reverse decomposition reaction to produce oxygen under other conditions. Unlike conventional methods, the process parameters may be optimized to obtain operating conditions substantially noncorrosive to conventional high-temperature alloys. Advantages of certain embodiments include reduced process corrosivity, lower cost, and lower energy demands. Optional features include energy economization with external processes and reduction of carbon dioxide footprint compared to currently available processes.

### CROSS-REFERENCE TO RELATED APPLICATIONS

This application is a non-provisional application which claims benefit under 35 USC §119(e) to U.S. Provisional Application Ser. No. 61/577,260 filed Dec. 19, 2011, entitled “ENHANCED OXYGEN GENERATION FROM MOLTEN SALT” which is incorporated herein in its entirety.

### STATEMENT REGARDING FEDERALLY SPONSORED RESEARCH OR DEVELOPMENT

None.

### FIELD OF THE INVENTION

The present invention relates generally to methods and systems for producing oxygen. More particularly, but not by way of limitation, embodiments of the present invention include methods and systems for continuous oxygen production through pressure and temperature swing absorption using molten salt under enhanced process conditions.

### BACKGROUND

Two major conventional methods are employed to produce about 100 million tons of oxygen extracted from air for industrial uses annually. The most common industrial method for large scale oxygen production is cryogenic air separation. Cryogenic distillation liquefies the air and separates it into its various components (e.g. nitrogen, oxygen, and inert gases) with nitrogen being obtained as overhead vapor while oxygen is produced as a bottoms liquid.

Unfortunately, cryogenic distillation remains unattractive due to its significant energy requirements and poor efficiency. Since the primary operating cost of oxygen production is the energy cost of liquefying the air, production costs vary directly with energy costs. In this way, the economics of cryogenic distillation is strongly linked to energy costs. Thus, as energy costs increase, so do the costs of cryogenic distillation. Accordingly, the higher energy costs are, the more economically unattractive cryogenic distillation is. Further, the cryogenic distillation process is well known to be thermodynamically inefficient and suffers from a low second law efficiency of approximately 20%.

Moreover, the cryogenic distillation process is predominantly driven by electrical power, which is often produced from the burning of high carbon fuels like coal. This combustion process results in a large carbon dioxide footprint for the cryogenic process.

The other major conventional method for producing oxygen is known as pressure swing adsorption using zeolite molecular sieves. In this method, a stream of air is passed through one bed of a pair of identical zeolite molecular sieves, which adsorbs the nitrogen and produces an effluent stream rich in oxygen from the bed. Simultaneously, nitrogen gas is released from the other nitrogen-saturated zeolite bed, by reducing the chamber operating pressure and diverting part of the oxygen gas from the producer bed through it, in the reverse direction of flow. After a set cycle time the operation of the two beds is interchanged, allowing a continuous supply of gaseous oxygen to be pumped through a pipeline.

Unfortunately, this process fails to deliver high purity oxygen and is limited to delivering a gas stream that is only about 90% to about 95% oxygen. This low oxygen recovery rate is insufficient for many applications. Additionally, pressure swing adsorption using zeolite molecular sieves suffers from high operating costs. Also, the cost of an adsorption system generally increases more rapidly as a function of production rate compared to cryogenic plants and are, therefore, more suitable for small production capacities.

Other methods exist for oxygen production such as electrolysis of water into molecular oxygen and hydrogen, electrocatalytic oxygen evolution from oxides and oxoacids, and chemical catalysts such as in chemical oxygen generators or oxygen candles. Another air separation technology involves forcing air to dissolve through ceramic membranes based on zirconium dioxide by either high pressure or an electric current, to produce nearly pure oxygen gas. For various reasons however, these remaining technologies remain unsuitable for widespread industrial production and use.

Another process that has been proposed for oxygen production is the MOLTOX™ system. This process proposes using molten salt in a pressure swing absorption (PSA) process or a thermal swing absorption (TSA) process. In this process, oxygen is removed from air by selective reaction of the oxygen with molten salt in an absorber. The molten salt then releases the oxygen in a desorber by a reverse reaction that is favored under the desorber conditions. In this way, oxygen production is proposed in this continuous process. This process can be designed to be predominantly driven by thermal energy, which can be produced from cleaner fuels like natural gas. This cleaner process in turn can lead to lower carbon dioxide footprint for the process.

In practice however, the molten salt system turns out to be highly corrosive at the conditions typically used in the process. This highly corrosive process requires use of expensive metallurgy for process equipment, which renders the process economically unattractive. Despite the fact that this process was initially proposed in the late 70's, no evidence exists for successfully overcoming this high corrosivity problem. Consequently, due in large part to this corrosivity obstacle, this process has never been industrially implemented. Additionally, while molten salt PSA or TSA processes promise reduced energy requirements as compared to cryogenic distillation methods, molten salt PSA/TSA processes continue to require economically significant energy use.

Accordingly, there is a need for enhanced oxygen production methods and systems that address one or more of the disadvantages of the prior art.

### SUMMARY

The present invention relates generally to methods and systems for producing oxygen. More particularly, but not by way of limitation, embodiments of the present invention include methods and systems for continuous oxygen production through pressure and temperature swing absorption using molten salt under enhanced process conditions.

One example of a continuous method for producing oxygen comprises the steps of: providing an absorber wherein the absorber is configured to accept an absorber feed, a gas mixture, and wherein the absorber is configured to provide an absorber bottoms and an absorber overheads; providing a desorber wherein the desorber is configured to accept a desorber feed and wherein the desorber is configured to provide a desorber bottoms and a desorber overheads; wherein the absorber bottoms is in fluid communication with the desorber feed and wherein the desorber bottoms is in fluid communication with the absorber feed; providing a molten salt mixture wherein the molten salt mixture comprises a catalytic agent and one of a metal nitrate salt and a metal nitrite salt, and; circulating the molten salt mixture in a continuous circulation loop through the absorber and the desorber; maintaining the desorber at a desorber temperature and a desorber pressure wherein the absorber temperature is less than the desorber temperature wherein the desorber temperature is from about 450° C. to about 605° C.; maintaining the absorber at an absorber temperature and an absorber pressure wherein the absorber pressure is greater than the desorber pressure wherein the desorber pressure is from about 0.1 atm to about 0.5 atm; introducing a gas mixture into the absorber by way of the gas mixture wherein the gas mixture comprises oxygen; allowing the oxygen in the gas mixture to react by way of an oxidation reaction with the nitrite salts in the molten salt mixture to form nitrate salts in the absorber; and allowing the nitrate salts in the desorber to react by way of a decomposition reaction to form nitrite salts so as to release oxygen in the desorber and allowing the oxygen to exit the desorber by way of the desorber overheads.

One example of a continuous method for producing oxygen comprises the steps of: providing an absorber wherein the absorber is configured to accept an absorber feed, a gas mixture, and wherein the absorber is configured to provide an absorber bottoms and an absorber overheads; providing a desorber wherein the desorber is configured to accept a desorber feed and wherein the desorber is configured to provide a desorber bottoms and a desorber overheads; wherein the absorber bottoms is in fluid communication with the desorber feed and wherein the desorber bottoms is in fluid communication with the absorber feed; providing a molten salt mixture wherein the molten salt mixture comprises a catalytic agent and one of a metal nitrate salt and a metal nitrite salt; circulating the molten salt mixture in a continuous circulation loop through the absorber and the desorber; maintaining the desorber at a desorber temperature and a desorber pressure wherein the absorber temperature is less than the desorber temperature wherein the desorber temperature is from about 300° C. to about 630° C.; maintaining the absorber at an absorber temperature and an absorber pressure wherein the absorber pressure is greater than the desorber pressure wherein the desorber pressure is from about 0.1 atm to about 0.5 atm; introducing a gas mixture into the absorber by way of the gas mixture wherein the gas mixture comprises oxygen; allowing the oxygen in the gas mixture to react by way of an oxidation reaction with the nitrite salts in the molten salt mixture to form nitrate salts in the absorber; and allowing the nitrate salts in the desorber to react by way of a decomposition reaction to form nitrite salts so as to release oxygen in the desorber and allowing the oxygen to exit the desorber by way of the desorber overheads.

The features and advantages of the present invention will be apparent to those skilled in the art. While numerous changes may be made by those skilled in the art, such changes are within the spirit of the invention.

### BRIEF DESCRIPTION OF THE DRAWINGS

A more complete understanding of the present disclosure and advantages thereof may be acquired by referring to the following description taken in conjunction with the accompanying figures, wherein:

FIG. 1 illustrates an example of a pressure and temperature swing absorption system in accordance with one embodiment of the present invention.

FIG. 2 illustrates a general schematic of a process for oxygen generation using molten salt.

FIG. 3 illustrates a comparison between APCI data and equilibrium model predictions for base case: (a) oxygen recovery, (b) oxygen production rate, (c) waste gas flow rate leaving the absorber, and (d) net thermal energy requirement for the process.

FIG. 4 illustrates the impact of absorber/desorber pressure on oxygen recovery at a desorption temperature of 921.9K.

FIG. 4A illustrates the impact of absorber/desorber pressure on differential nitrate concentration.

FIG. 5 illustrates the impact of desorber temperature on oxygen recovery at combined PSA/TSA mode of operation.

FIG. 6 illustrates the impact of salt circulation rate on oxygen recovery at combined PSA/TSA mode of operation (salt flow ratio=salt flow rate/salt flow rate in base case).

FIG. 7A illustrates the variation of oxygen recovery with absorber/desorber operating pressure at desorption temperature of 873K for PSA/TSA systems.

FIG. 7A illustrates the variation of oxygen recovery with salt circulation rate at desorption temperature of 873K for TSA and PSA/TSA systems.

FIG. 8A illustrates specific electrical energy demands under various operating conditions for oxygen generation with the molten salt process.

FIG. 8B illustrates net specific thermal energy demands under various operating conditions for oxygen generation with the molten salt process.

FIG. 9 illustrates the total energy demand (thermal energy equivalent) under various operating conditions for oxygen generation with the molten salt process.

FIG. 9A illustrates salt heater thermal duties under various operating conditions for oxygen generation with the molten salt process.

While the present invention is susceptible to various modifications and alternative forms, specific exemplary embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

The present invention relates generally to methods and systems for producing oxygen. More particularly, but not by way of limitation, embodiments of the present invention include methods and systems for continuous oxygen production through pressure and temperature swing absorption using molten salt under enhanced process conditions.

In certain embodiments, continuous methods for oxygen production use a molten salt mixture in a pressure and temperature swing absorption system. The process relies on the ability of the molten salt mixture to selectively absorb oxygen from a gas mixture (e.g. from air) under certain process conditions and subsequently desorb the oxygen from the molten salt mixture to produce oxygen under other process conditions. The molten salts comprise a mixture of nitrite and nitrate salts. Essentially, the molten salt mixture undergoes an oxidation reaction that converts nitrite salts into nitrate salts under process conditions that favor the oxidation reaction. In this way, the molten salt mixture removes oxygen from a gas mixture, e.g., air. Conversely, the molten salt mixture also undergoes a decomposition reaction that releases oxygen by converting nitrate salts into nitrite salts under process conditions which favor the decomposition reaction over the oxidation reaction.

In certain embodiments, these two reactions are carried out in separate vessels, referred to herein as an absorber and a desorber. The absorber operates at a lower temperature and a higher pressure to favor the oxidation reaction to remove oxygen from a gas mixture (e.g. air) that is introduced into the absorber. The oxygen-enriched molten salt mixture may then be circulated to the desorber that is operated at a higher temperature and a lower pressure, conditions which favor the reverse decomposition reaction. Accordingly, the molten salt mixture releases oxygen in the desorber, and in this way, oxygen is produced by separating oxygen from the gas mixture. Unlike conventional methods, the process parameters may be optimized to produce conditions which are substantially noncorrosive to conventional alloys. Other optional features such as energy economization with external processes are described in further detail below.

Advantages of certain embodiments of the present invention include one or more of the following: reduced process corrosivity, lower cost due to possible use of conventional alloys instead of expensive metallurgy, lower energy requirement, and smaller carbon dioxide footprint. Other advantages will be apparent from the following description.

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations that come within the scope of the invention.

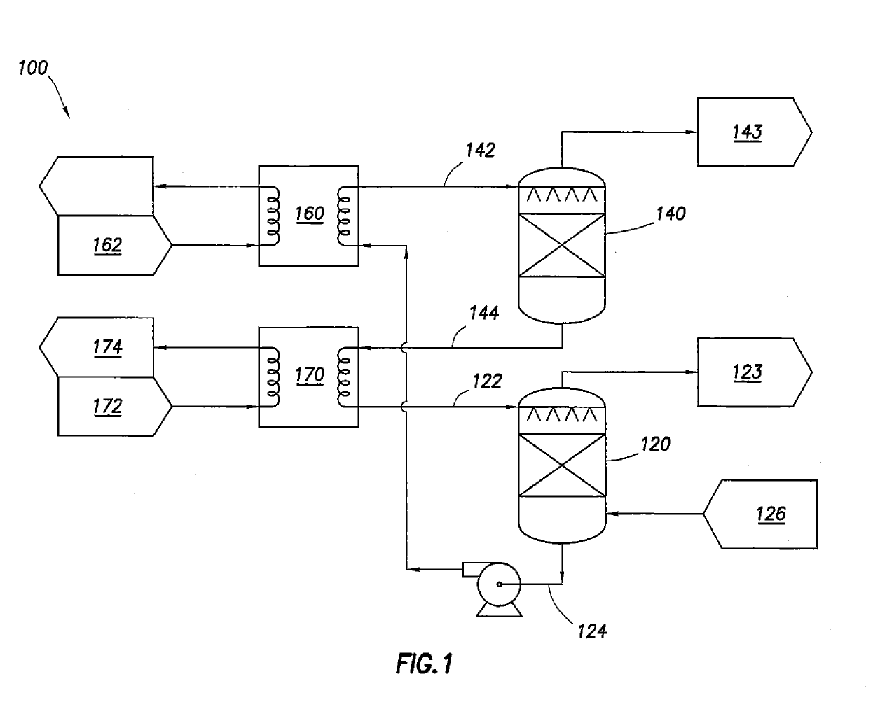

FIG. 1 illustrates an example of a pressure and temperature swing absorption system in accordance with one embodiment of the present invention. In this example, oxygen producing system 100 comprises absorber 120 and desorber 140. A molten salt mixture is circulated through absorber 120 and desorber 140.

Gas mixture 126 comprising oxygen is introduced to absorber 120 via gas mixture 126. Gas mixture 126 introduced to absorber 120 is any mixture of gas which comprises some amount of oxygen, at least a portion of which is to be removed from gas mixture 126 in absorber 120. In certain embodiments, gas mixture 126 comprises air.

Generally, an oxidation reaction occurs in absorber 120, whereas a reverse decomposition reaction simultaneously occurs in desorber 140. Absorber 120 is operated at process conditions that favor the oxidation reaction of oxygen with the circulating molten salt mixture whereas desorber 140 is operated at process conditions that favor the reverse decomposition reaction to evolve oxygen from the molten salt mixture.

The molten salt mixture comprises a mixture of nitrite salts, nitrate salts, and a catalytic agent. In the absorber, oxygen from gas mixture 126 reacts with the molten salt mixture by way of an oxidation reaction, which converts the metal nitrite salts to nitrate salts as follows:

MNO₂+½O₂→MNO₃ [Eqn. 1]

In this way, oxygen is removed from gas mixture 126. The remaining unreacted gas mixture exits the absorber via the absorber overheads 123. Where gas mixture 126 is air, the unreacted gas mixture will typically comprise nitrogen and some inert gases along with some unreacted oxygen.

The oxygen-enriched molten salt then leaves absorber 120 via absorber bottoms 124 and flows, directly or indirectly, to desorber 140 via desorber feed 142. Because desorber 140 is operated at lower pressures and higher temperatures than absorber 120, the process conditions of desorber 140 favor the reverse decomposition reaction of the oxygen-enriched molten salt mixture, which converts the metal nitrate salts to nitrite salts as follows:

MNO₃→MNO₂+½O₂ [Eqn. 2]

This decomposition reaction evolves oxygen which may then be produced from desorber 140 via desorber overheads 143. The oxygen-depleted molten salt mixture then exits desorber 140 by way of desorber bottoms 144 and returns to absorber 120, directly or indirectly, by way of absorber feed 122.

The process conditions favoring the oxidation reaction in absorber 120 include any suitable pressure and temperature conditions which favor the oxidation reaction in Equation 1 versus the decomposition reaction in Equation 2. Examples of suitable absorber pressures and temperatures include, but are not limited to, from about 1 atm to about 15 atm and from about 300° C. to about 630° C. Too low of an absorber pressure reduces the absorption rate due to the lower partial pressure of oxygen whereas too high of an absorber pressure increases the energy consumed by the gas compressor at the front end. On the other hand, too low of an absorber temperature reduces the rate of reaction whereas too high of an absorber temperature reduces the absorption rate due to the lower solubility of oxygen in the liquid phase. Other examples of suitable absorber pressures and temperatures include, but are not limited to, from about 1 to about 5 atm and from about 400° C. to about 500° C.

Process conditions favoring the oxidation reaction in desorber 140 include any suitable pressure and temperature conditions which promote the decomposition reaction in Equation 2 versus the oxidation reaction in Equation 1. Examples of suitable desorber pressures and temperatures include, but are not limited to, temperatures from about 450° C. to about 750° C., and pressures from about 0.1 atm to about 2 atm. The lower bound for pressure is generally limited by equipment size, salt loss by evaporation, and power required for the vacuum compressor. Other examples of suitable pressures and temperatures include, but are not limited to, temperatures from about 580° C. to about 605° C., and pressures from about 0.1 atm to about 0.5 atm. In some embodiments, the lower desorber temperature allows the process to continue with substantially less corrosivity than previously proposed process conditions while maintaining the oxygen productivity that was achieved at the previously proposed process conditions. This lower desorber operating temperature may be achieved by reducing the desorber pressure, by increasing the molten salt mixture circulation rate sufficiently, or both of the above as required to obtain a given oxygen recovery rate.

Accordingly, desorber 140 is typically operated at a higher temperature than absorber 120. To achieve this higher temperature, salt heater 160 heats the circulating salt after the molten salt mixture leaves absorber 120 before the molten salt mixture enters desorber 140. In certain embodiments, salt heater 160 is integral (not shown) to desorber 140 such that the molten salt mixture is heated within or in direct proximity to desorber 140.

Desorber temperatures above 605° C. are disfavored in certain embodiments as corrosion of the molten salt mixture increases significantly above this temperature. By maintaining the desorber temperature below this temperature, a great deal of conventional and relatively inexpensive high-temperature alloys may be used as the material of construction for desorber 140. Examples of suitable metallurgy that may be used with certain embodiments of the present invention include, but are not limited to, Inconel 600, Inconel 625 LCF, or any combination thereof.

To achieve the desired operating temperature in absorber 120, salt cooler 170 cools the molten salt mixture leaving desorber 140 before absorber 120. In certain embodiments, salt cooler 170 is integral (not shown) to absorber 120 such that the molten salt mixture is cooled within or in direct proximity to absorber 120.

Oxygen recovery rates using the process conditions described herein include, but are not limited to, oxygen recovery rates of about 80% to about 99%, at least about 90%, and more preferably about 95%. The circulation rate of the molten salt mixture may be increased for a given set of process conditions (e.g. absorber and desorber pressures and temperatures) until the desired oxygen recovery rate is achieved. Otherwise, the desorber pressure may be adjusted (e.g. while keeping other process conditions unchanged) for a preferred salt circulation rate to achieve the desired oxygen recovery rate. Examples of suitable molten salt circulation rates include about 4 to about 16 mol salt per mol air fed to the absorber depending on the process conditions used and oxygen recovery rate desired, or any combination thereof.

Gas mixture 126 may be preheated to the absorber temperature or close to the absorber temperature if desired. Gas mixture 126 may also be pressurized to maintain an elevated absorber pressure as desired. The efficiency of the reactions may be improved by enhancing the intimate mixing of the molten salt mixture with the gases. In certain embodiments, absorber 120 and/or the desorber 140 are either multi-stage countercurrent towers or packed bed columns. For example, in either configuration of the countercurrent absorber, the molten salt mixture would typically be introduced at the top of the tower and flow under the influence of gravity, while gas mixture 126 is introduced near the bottom of absorber 120. In this way, intimate contact between the molten salt and gas mixture 126 is maximized.

Further efficiency gains may be realized by economizing various aspects of the process. For example, salt heater 160 requires a substantial amount of heat to heat the molten salt mixture to the desired desorber 140 temperature. This heat is supplied by heated fluid 162, which may be a gas, liquid, or both. In certain embodiments, heated fluid 162 comprises steam. Accordingly, because salt heater 160 requires heated fluid 162, oxygen producing system 100 may benefit from integration with other processes that produce steam or other heated fluids capable of providing all or a portion of the duty required by salt heater 160.

Likewise, salt cooler 170 may benefit from integration with any process that benefits from the heat generated by salt cooler 160 for cooling the molten salt mixture. In some embodiments, water 172 is fed to salt cooler 160, which is then converted to steam 174 by indirect heat exchange. Steam 174 may be supplied to any other process, including, but not limited to, SAGD processes. SAGD processes or Steam Assisted Gravity Drainage processes use steam downhole to enhance the recovery of heavy oils from bitumen reservoirs. Thus, when oxygen producing system 100 is combined with steam-consuming processes such as SAGD, energy produced by salt cooler 170 may be leveraged to save energy consumption in the other processes.

In certain embodiments, the molten salt mixture comprises from about 74% to about 99% of metal nitrate salt, from about 1% to about 26% metal nitrite salt, and from about 1% to about 3% catalytic agent (or in some embodiments, about 0.2 mol % to about 1 mol %). The catalytic agent is any catalyst suitable for catalyzing the oxidation and decomposition reactions of the molten salt. Examples of suitable catalytic agents include, but are not limited to, peroxides, superoxides, metal oxides, or any combination thereof. In certain embodiments, the molten nitrate salt comprises one or more alkali metal nitrates. The alkali metal may include potassium, sodium, lithium, or any combination thereof.

The processes described herein may benefit from further enhancements, such as including oxygen scavengers in the molten salt to enhance oxygen removal and/or the addition of a stripping gas in the desorber. Suitable oxygen scavengers include, but are not limited to, Cu—Cu₂O, Cu₂O—CuO, FeO—Fe₃O₄, Fe₃O₄—Fe₂O₃, Ni—NiO, Co—COO, CoO—Co₃O₄, MnO—Mn₃O₄, Mn₃O₄—Mn₂O₃, MoO₂—MoO₃, V₈O₁₅—VO₂, VO₂—V₂O₅, Sb—Sb₂O₃, Cr₂O₃—CrO₂, Pb—PbO, Bi—Bi₂O₃, or combinations thereof.

It is recognized that any of the elements and features of each of the devices described herein are capable of use with any of the other devices described herein without limitation. Furthermore, it is recognized that the steps of the methods herein may be performed in any order except unless explicitly stated otherwise or inherently required otherwise by the particular method.

To facilitate a better understanding of the present invention, the following examples of certain embodiments are given. In no way should the following examples be read to limit, or define, the scope of the invention.

### Examples

The model for the absorption/desorption cycle for the separation of oxygen from air using molten salts is developed assuming kinetic equilibrium in the absorber and desorber. An isothermal and isobaric operation is also assumed at this stage for the sake of simplicity of the model. The contactors could have been considered to be non-isothermal, but that would increase the complexity and require the solution of coupled non-linear equations. However, this simplified model predicts general trends and shows the effects of the operating parameters on the performance of the oxygen production cycle.

The process modeling part of this study is carried out using the Aspen Plus (version 7.1) process simulation software. This is performed with selected process conditions that are identified based on the results from the equilibrium model. The low pressure high temperature (649° C.) thermal swing data reported in Kang et al. (1988) is used as the base case. The process parameters, i.e. temperature, pressure and salt circulation rate, are varied around their base case values in the equilibrium model. The inlet air feed rate to the absorber is kept constant for all the simulation conditions.

### Equilibrium Model for Absorption/Desorption Cycle

The equilibrium model for the absorption/desorption cycle considers four chemical species in the system—oxygen (1), metal nitrate (2), metal nitrite (3) and nitrogen (4). The reactions taking place in the absorber and desorber involving these components are:

Absorber:2MNO₂+O₂ [symbol] 2MNO₃

Desorber:2MNO₃ [symbol] 2MNO₂+O₂

In addition, the following assumptions are made to derive the model equations:
(i) The operations of the absorber and desorber are isothermal and isobaric.
(ii) Kinetic equilibrium is achieved instantaneously in the absorber and desorber.
(iii) The liquid and gas phases are perfectly mixed and ideal.
(iv) The salt consists of only nitrate and nitrite and no decomposition of the salt occur.
(v) The salt is non-volatile.
(vi) Nitrogen is insoluble in the salt.

### Kinetic Equilibrium in the Absorber and Desorber:

$${K}_{a} = \frac{{x}_{2 a}^{2}}{{x}_{3 a}^{2} {p}_{1 a}}$$

$${K}_{d} = \frac{{x}_{3 d}^{2} {p}_{1 d}}{{x}_{2 d}^{2}}$$

K=equilibrium constant at absorber temperature
K_{d}=equilibrium constant at desorber temperature
x₂ₐ, x₃ₐ=mole fractions of nitrate and nitrite in the oxygen-loaded salt exiting the absorber
x_{2d}, x_{3d}=mole fractions of nitrate and nitrite in the oxygen-depleted salt exiting the desorber
p₁ₐ=partial pressure of oxygen in the waste gas leaving the absorber
p_{1d}=partial pressure of oxygen in the product stream leaving the desorber

Also, x₂ₐ+x₃ₐ=1 and x_{2d}+x_{3d}=1.

Absorber Nitrate Balance:

x_{2d}Mₛₐₗₜ−x₂ₐMₛₐₗₜ=R₂ₐ
Mₛₐₗₜ=total molar flow rate of salt being circulated
R₂ₐ=moles of nitrate consumed in the absorber
Note that the salt molar flow rate remains constant during the absorption/desorption cycle because of the stoichiometry—two moles of nitrite forms two moles of nitrate in the absorber while two moles of nitrate produces two moles of nitrite in the desorber keeping the total moles of circulating salt (sum of nitrate and nitrite) unchanged.

### Absorber Oxygen Balance.

y₁^{air}Mₐᵢᵣ−y₁^{waste}M_{waste}=R₁ₐ
y₁^{air}=mole fraction of oxygen in the inlet air to the absorber waste
y₁^{waste}=mole fractions of oxygen in the outlet waste gas from the absorber
Mₐᵢᵣ=molar flow rate of air entering the absorber
M_{waste}=molar flow rate of waste gas leaving the absorber
R₁ₐ moles of oxygen consumed in the absorber

Further, reaction stoichiometry requires that

$$\frac{{R}_{1 a}}{{R}_{2 a}} = \frac{{v}_{1 a}}{{v}_{2 a}} ,$$

where v=stoichiometric coefficients of the species involved in the reaction (negative for reactants and positive for products). Also, p₁ₐ=y₁^{air}Pₐ and p_{1d}=P_{d} (since pure oxygen is the only product from the desorber)—Pₐ, P_{d} being the operating pressures of the absorber and desorber respectively.

### Absorber Nitrogen Balance:

y₄^{air}Mₐᵢᵣ−y₄^{waste}M_{waste}=0
y₄^{air}=mole fraction of nitrogen in the inlet air to the absorber
y₄^{waste}=mole fractions of nitrogen in the outlet waste gas from the absorber
Also, y₁^{air}+y₄^{air}=1 and y₁^{waste}+y₄^{waste}=1.
   The equations shown above can be simplified to yield the following set:

$$\begin{matrix}{K}_{a} = \frac{{x}_{2 a}^{2}}{{( 1 - {x}_{2 a} )}^{2} {y}_{1}^{waste} {P}_{a}} & ( E1 ) \\ {K}_{d} = \frac{{( 1 - {x}_{2 d} )}^{2} {P}_{d}}{{x}_{2 d}^{2}} & ( E 2 ) \\ ( {x}_{2 d} - {x}_{2 a} ) {M}_{salt} = \frac{{v}_{2 a}}{{v}_{1 a}} ( {y}_{1}^{air} {M}_{air} - {y}_{1}^{water} {M}_{waste} ) & ( E 3 ) \\ {M}_{waste} = \frac{( 1 - {y}_{1}^{air} ) {M}_{air}}{1 - {y}_{1}^{waste}} & ( E 4 )\end{matrix}$$

Equations (E1) through (E4) can be solved for the four unknowns x₂ₐ, x_{2d}, y₁^{waste} and M_{waste} when the operating temperatures, pressures, salt circulation rate and air flow rate to the absorber are known. Note that the temperatures of the absorber and desorber are necessary to determine the equilibrium constants Kₐ and K_{d} respectively which are functions of temperature.

The molar flow rate of product oxygen from the desorber can then be calculated utilizing the oxygen and nitrate balances in the desorber, which are as follows—

### Desorber Oxygen Balance:

−M_{oxygen}=R_{1d}
M_{oxygen}=molar flow rate of oxygen from the desorber
R_{1d}=moles of oxygen consumed in the desorber

### Desorber Nitrate Balance:

x₂ₐMₛₐₗₜ−x_{2d}Mₛₐₗₜ=R_{2d}
R_{2d}=moles of nitrate consumed in the desorber

Again, reaction stoichiometry requires that

$$\frac{{R}_{1 d}}{{R}_{2 d}} = \frac{{v}_{1 d}}{{v}_{2 d}} ,$$

and therefore, the oxygen production rate becomes:

$${M}_{oxygen} = - \frac{{v}_{1 d}}{{v}_{2 d}} ( {x}_{2 a} {M}_{salt} - {x}_{2 d} {M}_{salt} ) \qquad ( E5 )$$

The oxygen recovery in the absorption/desorption cycle is defined as the ratio of the amount of oxygen produced from the desorber to the amount of oxygen in the air that is fed to the absorber, and is given by

$$Oxygen recovery ( \% ) = \frac{{M}_{oxygen}}{{y}_{1}^{air} {M}_{air}} \times 100 \qquad ( E6 )$$

The kinetic equilibrium constant at temperature T is calculated as

$$K = exp ( - \frac{Δ G}{RT} ) \qquad ( 7 )$$

ΔG is the Gibbs free energy of the reaction being considered, which is defined as ΔG=ΔH TΔS, where ΔH and ΔS are the enthalpy and entropy change of the reaction respectively. Archer and Dunbobbin (1985) reported that for the reaction 2MNO₃ [symbol] 2MNO₂+O₂, where M is 50 mol % sodium and 50 mol % potassium, the ΔH and ΔS are 46.0 kcal/mol O₂ (193.2 kJ/mol O₂) and 41.3 cal/mol O₂—K (173.4 J/mol O₂—K) respectively.

The process variables for the base case (thermal swing cycle) is obtained from the report by Kang et al. (1988). The air flow rate is 5,920.55 kmol/hr containing 21% oxygen and 79% nitrogen, while the salt circulation rate is estimated to be 31,574.91 kmol/hr. The inlet temperature of the air and salt streams to the absorber is 454.4° C. (727.4K), while desorption takes place at a temperature of 648.9° C. (921.9K). The operating pressures of the absorber and desorber are 1.293 atm and 1.123 atm respectively.

### Process Model

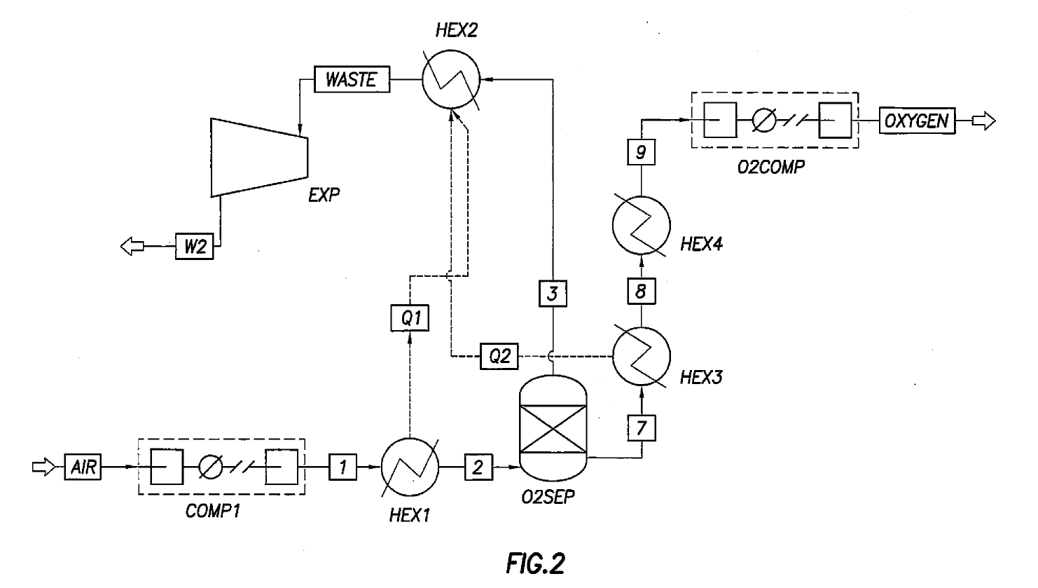

The general schematic of the process model is shown in FIG. 2. The air is compressed adiabatically to the absorber pressure, heated to the absorber temperature and is fed to the oxygen separation block (O2SEP). The performance of this separation block is provided from the results of the equilibrium model obtained with the desired operating conditions. The hot waste gas from the absorber and the product oxygen from the desorber are used to heat the inlet air feed prior to separation. When the absorber is operated at a high pressure, the waste gas that is rich in nitrogen is expanded in a turbine to recover power before being vented to the atmosphere. On the other hand, when the desorber is operated at sub-atmospheric pressure (vacuum), the product oxygen is evacuated using a vacuum compressor.

The thermal duty necessary to raise the temperature of the salt from the absorber to desorber temperature (salt heater) is estimated from the salt circulation rate and composition at the exit of the absorber that is obtained from the equilibrium model. Similarly, the cooling duty from the salt cooler, which reduces the salt temperature from the desorber to absorber condition, is estimated from the salt circulation rate and composition at the exit of the desorber. The nitrate is assumed to have an average specific heat of 140 J/mol-K (based on data from Yaws handbook of thermodynamic properties of hydrocarbons and chemicals for sodium and potassium nitrates) and an average molecular weight of 93, while the nitrite is assumed to have an average specific heat of 116 J/mol-K (based on data from Iwadate et al., 1982 for sodium nitrite) and an average molecular weight of 77.

The power required to pump the salt from the desorber to the absorber pressure is estimated using Aspen Plus assuming the salt to be sodium nitrate. A pump efficiency of 60% is used based on the example provided in the patent by Erickson (1982). A pressure drop of 0.35 atm. is used for each of the salt heater and cooler. In the thermal swing (TSA) data presented by Kang et al. (1988), an electrical demand of 19.92 kWh/MT O₂ had been mentioned apart from the air compressor load. This is likely because of the salt pump and pre-purification of the air stream (a refrigeration block is shown in the pre-purification schematic shown in the report). In this study, the calculated pump duty (using Aspen Plus) for the base case is subtracted from the additional load estimated using 19.92 kWh/MT to obtain the electrical load for the pre-purification unit. This power requirement for the purification of the air stream is assumed to be identical for the other cases since the air flow rate is kept unchanged from the base case for all conditions investigated.

### Equilibrium Modeling Results

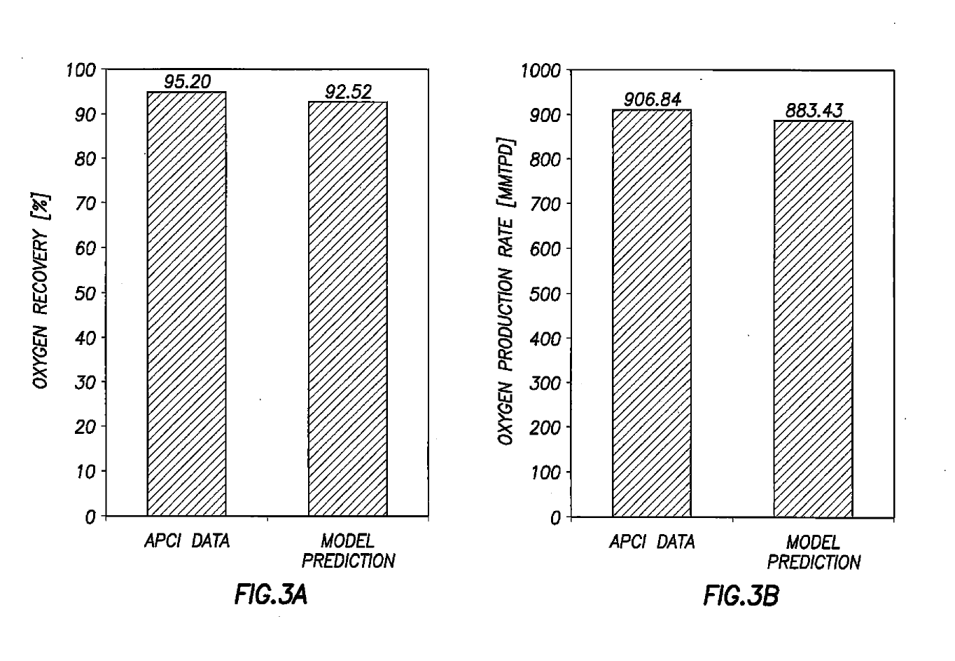

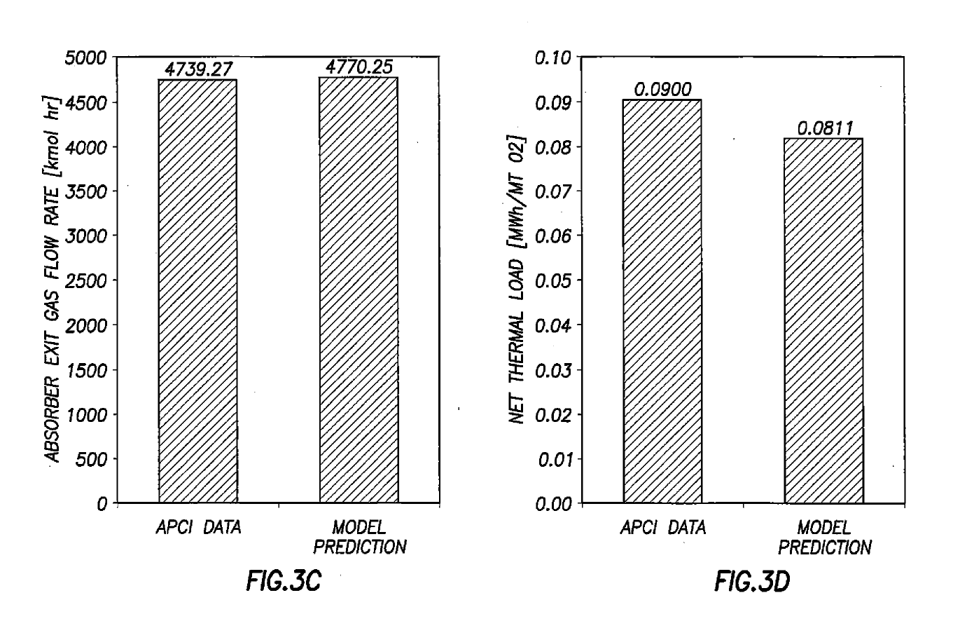

The equilibrium model is first solved with the base case parameters to compare the predictions of the model against the data reported by Air Products (Kang et al., 1988). As depicted in FIG. 3, four parameters are compared—oxygen recovery from the feed air stream, total oxygen production rate from the system, the flow rate of the waste gas stream leaving the absorber, and the net thermal energy (difference of the energy spent in the salt heater to the energy recovered in the salt cooler) required to drive the process. Overall, the APCI data and the model predictions can be seen to be in good agreement. Thus, this simplified model can be adequately used to predict general trends and understand the effects of the operating parameters on the process performance.

### Impact of Absorber/Desorber Pressure on Oxygen Recovery

The base case adopted in this study is a low pressure, thermal swing cycle, the performance of which has been reported by Air Products (Kang et al., 1988). However, the design basis for their 0.25 TPD pilot plant indicates that a combined pressure/thermal swing mode (PSA/TSA) was used for operation (Dunbobbin and Brown, 1987). The pressures of the absorber and desorber were 60 psia (4.08 atm.) and 20 psia (1.36 atm.) respectively. The outlet temperature from the absorber was 510° C. while that from the desorber was 649° C.

The PSA cycle can be coupled to the TSA scheme in one of the two following ways:
(a) The absorber is operated at super-atmospheric pressure while the desorber runs at atmospheric pressure. This is identical to that adapted by Air Products for the pilot study.
(b) The absorber is operated at atmospheric pressure while the desorber runs at sub-atmospheric pressure (vacuum).

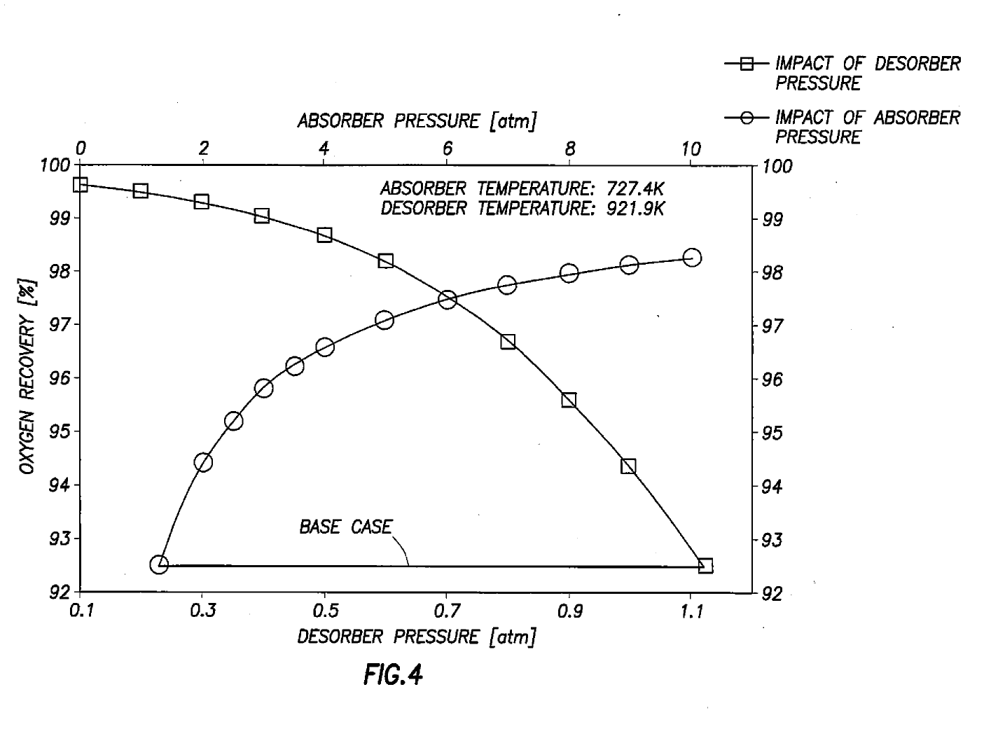

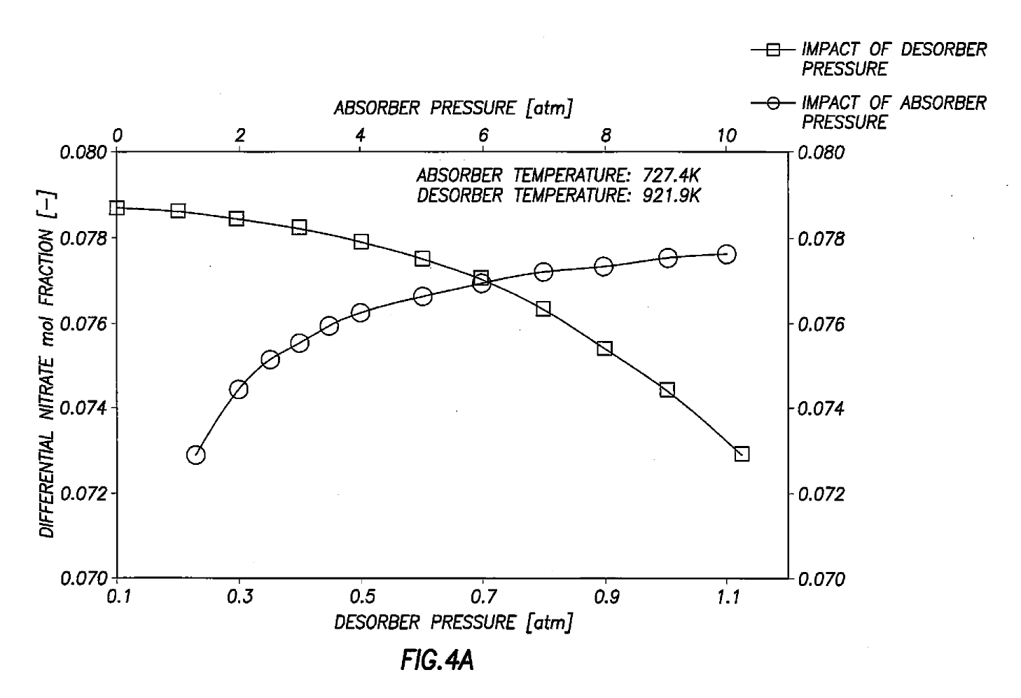

The impact of combining the PSA/TSA cycles as described above to produce oxygen with the molten salt process is depicted in FIG. 4. In the first case (a), the absorber pressure is varied from 1.293 atm. (base case) to 10 atm. while the desorption takes place at 1.123 atm. (base case). For the other case (b), the desorber pressure is varied from 1.123 atm. (base case) to 0.1 atm. while the absorption takes place at 1.293 atm (base case). The lower limit of 0.1 atm. for the second case is selected based on the patent by Erickson (1982). It has been mentioned in the patent that 0.1 atm. is the minimum practical desorption pressure accounting for the equipment size, salt loss by evaporation and power required for the vacuum compressor. For both cases (a) and (b), all other process parameters (temperatures, air flow rate and salt circulation rate) are maintained identical to those in the base case.

As seen in FIG. 4, the oxygen recovery increases when the PSA is coupled with the TSA cycle either by increasing the absorber pressure or by decreasing the desorber pressure. The base case oxygen recovery of 92.52% is also marked on the figure for reference. The combination of PSA/TSA increases the differential nitrate concentration between the absorber and desorber (shown in FIG. 4A), which increases the absorption of oxygen in the absorber. This leads to the higher oxygen recovery from the process when the PSA/TSA is coupled.

Further, it can be observed in FIG. 4 that the rate of increase in oxygen recovery is significantly slower above an absorber pressure of about 4 atm. or below a desorber pressure of about 0.5 atm. Therefore, in order to operate the process in a combination of pressure and thermal swing mode, either an absorber pressure of around 4 atm. or a desorber pressure of around 0.5 atm. is likely to be the optimum choice. This is in agreement with the operating condition (Dunbobbin and Brown, 1987) of the Air Products' pilot plant, which was designed for an absorber pressure of 60 psia (4.08 atm.). At an absorber pressure of 4 atm. the oxygen recovery is predicted to be 96.75%, which is more than 4 percentage points higher compared to that predicted for the base case (92.52%). However, the oxygen recovery is even higher at 98.93% when the desorber pressure is reduced to 0.5 atm. In fact, any desorber pressure below 0.6 atm. leads to oxygen recovery that is as high as or higher than that obtained with an absorber pressure of 10 atm. Thus, improved process performance can be achieved when the desorber pressure is lowered instead of increasing the absorber pressure to couple the PSA/TSA cycles.

### Impact of Desorber Temperature on Oxygen Recovery

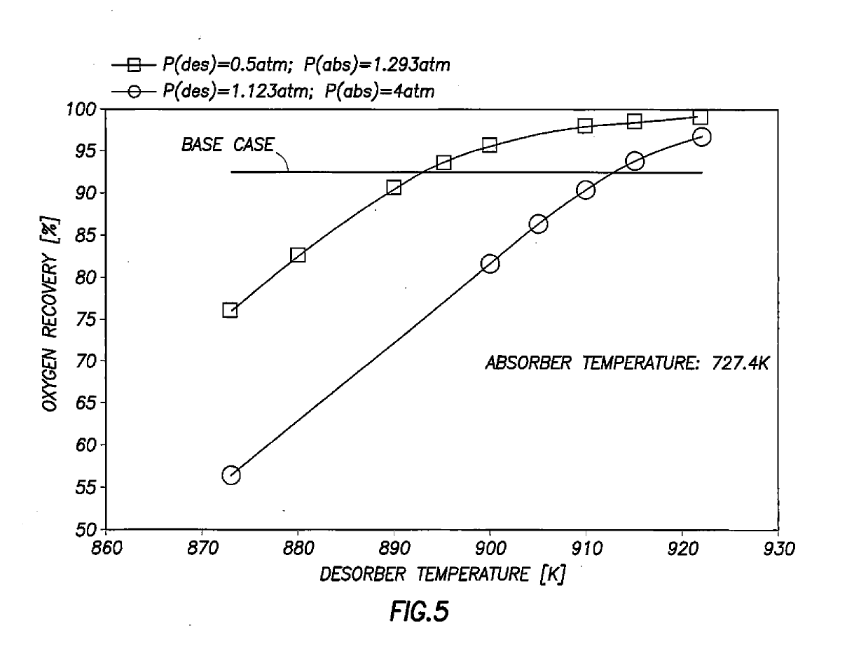

The impact of desorption temperature on the oxygen recovery is presented in FIG. 5. The process is operated in PSA/TSA mode with either the absorber at 4 atm. or the desorber at 0.5 atm. The goal is to understand the benefit of the combined cycle, if any, in reducing the operating temperature of the desorber. It is desired to decrease the desorber temperature to 873K (600° C.) if possible, to minimize corrosion problems with the circulating molten salts. All other process parameters are kept identical to the base case for these simulations.

It can be seen in FIG. 5 that, in general, the oxygen recovery decreases as the desorption temperature is reduced. This is due to the decrease in the differential nitrate concentration between the absorber and desorber when the desorber temperature decreases. However, the oxygen recovery is significantly more sensitive to the desorber temperature when the absorption pressure is 4 atm. This can be observed from the rate at which the oxygen recovery drops as the temperature is reduced for the two cases shown in FIG. 5. The decrease in oxygen recovery is substantially slower when the desorber is operated at a pressure of 0.5 atm. At the desired desorption temperature of 873K (600° C.), the oxygen recovery is reduced to 56% compared to the base case value of 92.52% when the absorber is at 4 atm. In this case, the desorber temperature can only be reduced by 7-8 degrees from 649° C. while maintaining the oxygen productivity of the base case. In comparison, the oxygen recovery is 75.90% when the desorber temperature and pressure are 873K and 0.5 atm. respectively. Under this condition, the desorber temperature can be reduced by about 30 degrees at identical oxygen productivity as the base case.

### Impact of Salt Circulation Rate on Oxygen Recovery

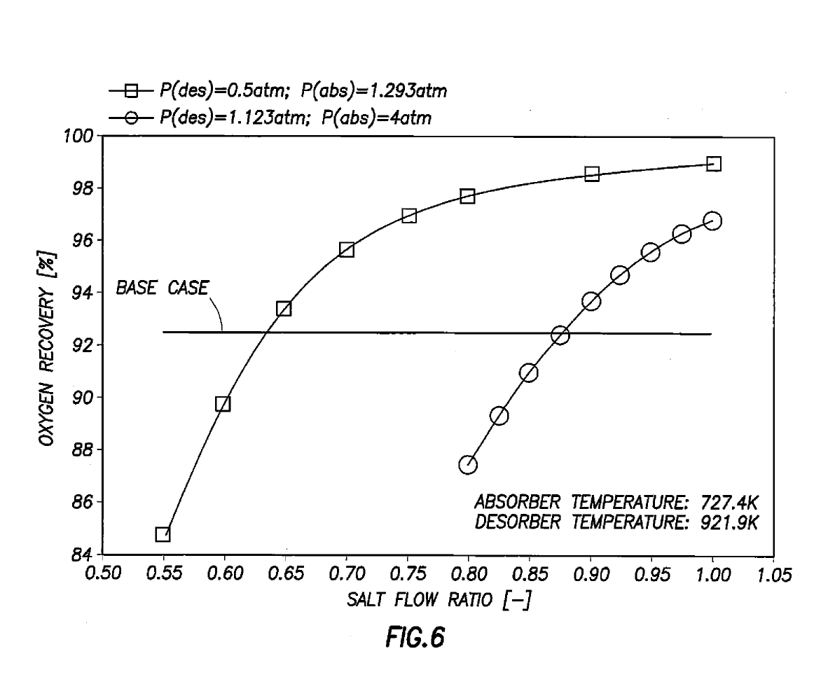

The impact of salt circulation rate on the oxygen recovery is shown in FIG. 6. The process is operated in PSA/TSA mode with either the absorber at 4 atm. or the desorber at 0.5 atm. All other process parameters are maintained at the base case values for these simulations. The goal is to examine whether the PSA/TSA coupling can lead to significant reductions in the amount of salt being circulated in the absorption/desorption cycle. A smaller salt flow rate is always preferable for the process to reduce the thermal duties, and hence, the footprints of the salt heater and cooler.

The salt flow ratio on the abscissa of FIG. 6 is defined as the ratio of the salt circulation rate in a given case to the rate in the base case. Therefore, a salt flow ratio of unity indicates that the salt circulation rate is same as that in the base case. FIG. 6 shows that decrease in the salt flow ratio decreases the oxygen recovery, the effect being significantly more when the absorber pressure is 4 atm. Under this condition, an oxygen recovery similar to the base case (92.52%) is achieved at a salt flow ratio of around 0.88, thereby reducing the salt circulation rate by about 12%. On the other hand, if the desorption takes place at 0.5 atm., the salt circulation rate can be reduced by about 35% (salt flow ratio of 0.65) while the base case oxygen recovery is achieved. Moreover, it can be observed that in this case the oxygen recovery curve is fairly flat at salt flow ratios above 0.75, the increase in oxygen recovery being only 2 percentage points (96.92% to 98.93%) when the salt flow ratio is increased from 0.75 to 1.0. This indicates that, when the desorption pressure is kept at 0.5 atm., the salt circulation can be reduced by 25% while maintaining an oxygen recovery which is comparable to that obtained with a salt flow ratio of unity. The oxygen recovery is still 4 percentage points higher (96.92%) compared to the base case value of 92.52%.

Is Desorber Temperature of 873K Achievable with Base Case Oxygen Recovery?

The preceding paragraphs have demonstrated that the use of a coupled PSA/TSA cycle for oxygen production with molten salts can either reduce the desorption temperature by 30 degrees or decrease the salt circulation rate by 35% compared to the low pressure TSA system (base case). These results are achieved when the PSA is combined with the TSA cycle by decreasing the pressure of the desorber. The benefits of the coupling are substantially reduced when it is performed by increasing the absorber pressure as was done for the Air Products' pilot study.

However, the use of conventional high temperature alloys as material of construction would warrant the operating temperature of the desorber to be at most 873K, which is 49 degrees lower than the base case. Further, a high oxygen recovery comparable to the base case will also be necessary to make the process efficient. It is unknown from the existing literature if this is achievable at all, and if affirmative, what changes need to be made to the operating variables to realize that effect. At fixed temperatures of the absorber/desorber and air flow rate, the absorber/desorber pressures and salt circulation rate can be varied to investigate the feasibility of operating the desorber at 873K.

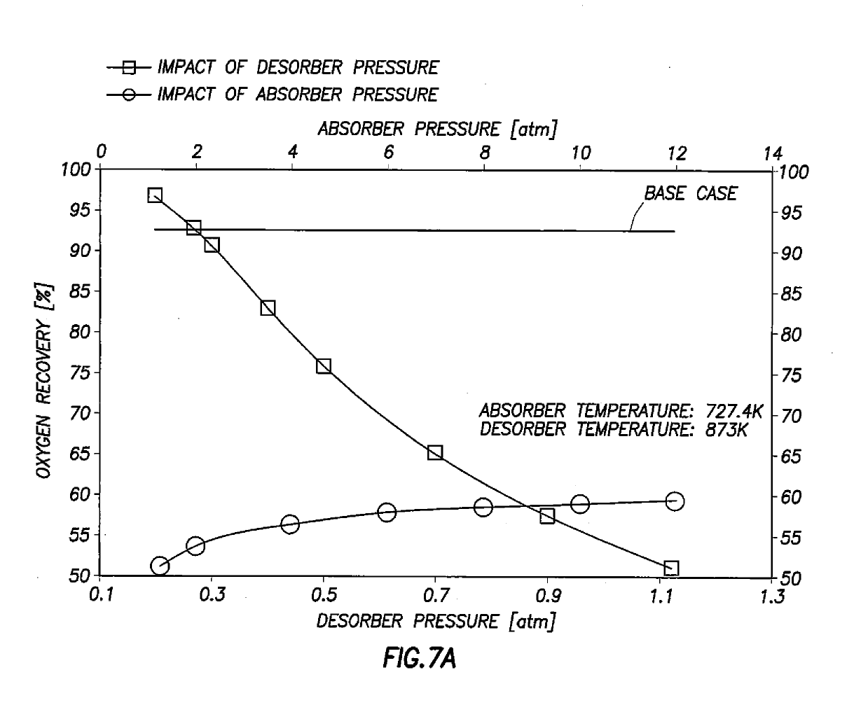

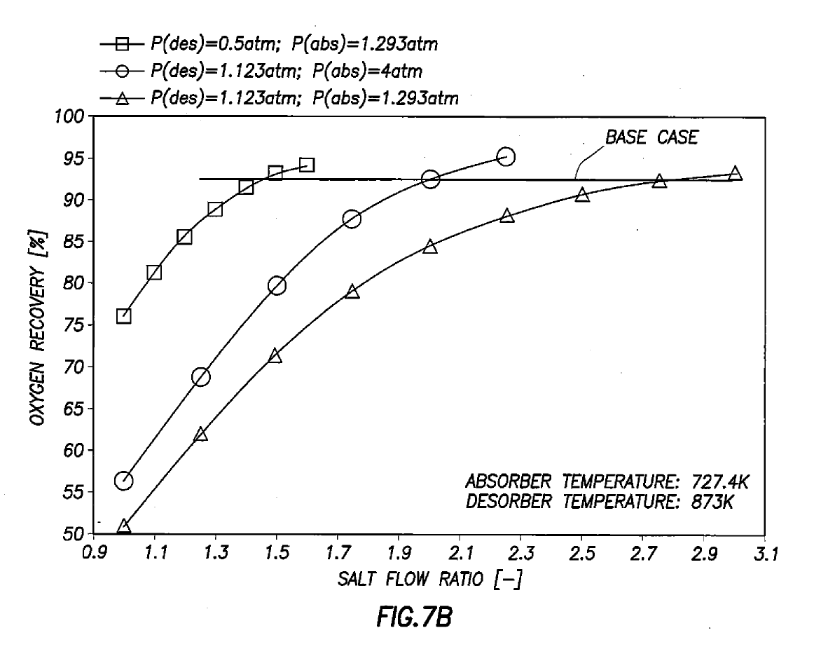

FIG. 7A depicts the variation of oxygen recovery with absorber/desorber pressure at the desorption temperature of 873K for coupled PSA/TSA cycle. When the absorber temperature is varied from 1.293 atm. to 12 atm., the desorber pressure and salt circulation rate are kept constant at the base case values. Similarly, the absorber pressure and salt circulation rate are kept constant at the base case values when the desorber pressure is varied between 1.123 atm. and 0.2 atm. As seen in FIG. 7A, operating the desorber at 873K and achieving the base case oxygen recovery (92.52%) is possible when the desorber pressure is about 0.27 atm. in the PSA/TSA cycle. On the other hand, a PSA/TSA cycle with super-atmospheric (as high as 12 atm.) absorber pressure can never lead to the base case oxygen recovery at the desorption temperature of 873K. The oxygen recovery levels off below 60% at high absorption pressures. Therefore, operating the desorber at sub-atmospheric pressure is the only option to obtain the base case oxygen recovery at 873K if increase in salt circulation rate is not warranted.

The influence of salt flow ratio on the oxygen recovery is presented in FIG. 7B with the desorption taking place at 873K. Two PSA/TSA conditions and one TSA condition are selected—the absorber pressure is 4 atm. or the desorber pressure is 0.5 atm. when the PSA/TSA is combined, while the absorber/desorber pressures are at their base case values when the TSA is used. Under all three conditions, the oxygen recovery increases as the salt circulation is increased, and it is possible to achieve a recovery comparable to the base case by tuning the salt flow rate. As observed from FIG. 7B, the PSA/TSA cycle with desorption pressure of 0.5 atm. requires a salt circulation of 1.5 times the base case, while the PSA/TSA cycle with absorption pressure of 4 atm. necessitates a salt circulation of 2 times the base case. The TSA system at base case operating pressures can also lead to the base case oxygen recovery at a salt circulation rate that is 2.75 times that of the base case.

### Process Modeling Results

In order to understand the effect of various parameters and operating conditions on the energy requirement of the oxygen generation system, process modeling needs to be performed. Based on the results obtained with the equilibrium model for the absorption/desorption cycle (O2SEP block in FIG. 2), seven cases are identified for process modeling and comparison with the cryogenic air separation unit.

These are as follows:
Case 1: TSA with desorber temperature 921.9K (base case)
Case 2: TSA with desorber temperature 873 K—salt flow 2.75 times that of base case
Case 3A: PSA/TSA with absorption at 4 atm. and desorber temperature 921.9K—salt flow 0.88 times that of base case
Case 3B: PSA/TSA with desorption at 0.5 atm. and desorber temperature 921.9K salt flow 0.65 times that of base case
Case 4A: PSA/TSA with absorption at 4 atm. and desorber temperature 873K—salt flow twice that of base case
Case 4B: PSA/TSA with desorption at 0.5 atm. and desorber temperature 873K—salt flow 1.5 times that of base case
Case 5: PSA/TSA with desorption at 0.27 atm. and desorber temperature 873K—salt flow same as base case

The process conditions for cases 2 to 5 are selected from the equilibrium modeling study such that the oxygen recoveries are identical to that obtained from the base case (92.52%). The air flow rate is constant at the base case value for all the cases.

### Specific Electrical Energy Demand

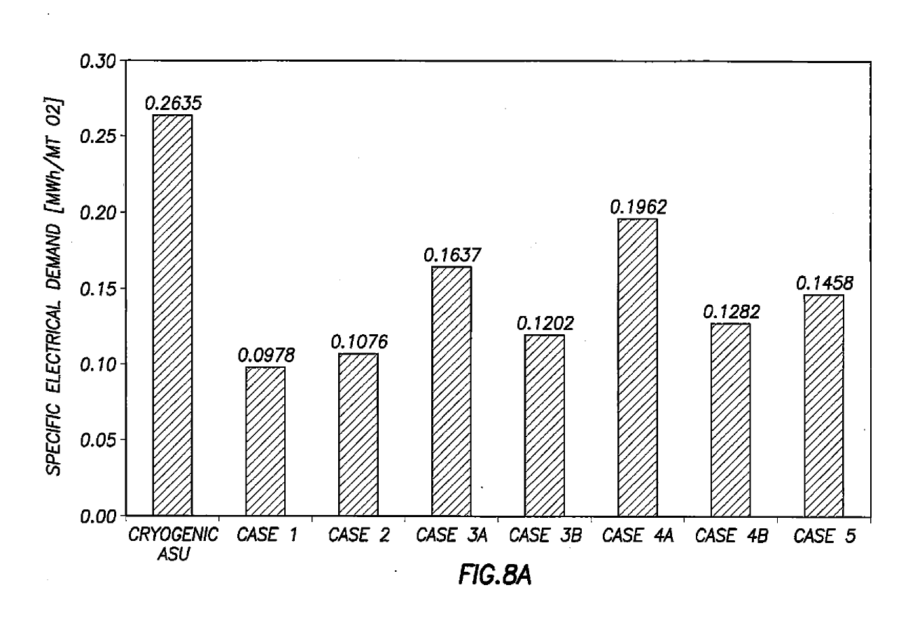

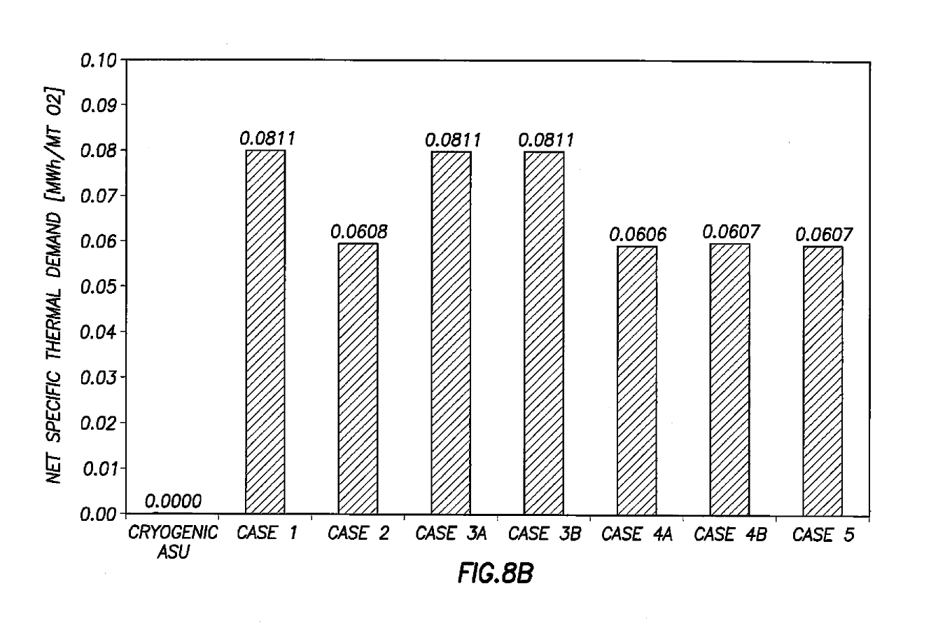

The specific electrical energy demands for the various cases with molten salts are compared to the cryogenic unit in FIG. 8A. The cryogenic system is high on electrical energy with a load of 0.2635 MWh/MT when oxygen of 99.5% purity is produced at low pressure. The base case (case 1) has the lowest power requirement due to the temperature swing mode used for operation. Because of the same reason, the power needed for case 2 is lower than all the other PSA/TSA cases considered. The higher electrical load in case 2 compared to the base case is because of the significantly larger salt flow required to achieve the oxygen recovery of the base case.

The electrical duty increases when the PSA/TSA combination is used in cases 3 to 5. This is primarily due to the additional energy consumed either by the air compressor to raise the pressure of the inlet air or the vacuum compressor to evacuate the product oxygen. The power required for the salt pump, which raises the pressure of the salt from the desorber before being fed to the absorber, also increases in the PSA/TSA mode. The interesting observation that can be made from FIG. 8A is that the PSA/TSA cases with sub-atmospheric desorption pressures (3B, 4B and 5) have substantially lower electrical energy demands compared to those with super-atmospheric absorber pressure (3A and 4A). This indicates that compressing the inlet air to 4 atm. is considerably more energy expensive than evacuating the oxygen from the desorber at 0.5 atm. or 0.27 atm. This is in spite of the fact that energy is recovered by expanding the nitrogen-rich waste stream when the absorber is operated at a higher pressure. Case 3B has the lowest electricity requirement among all the PSA/TSA cases shown in the figure.

### Specific Thermal Energy Demand

The net specific thermal duties predicted for the selected cases are shown in FIG. 8B. The net thermal duties indicate the difference in thermal energy provided to the salt heater and the thermal energy obtained from the salt cooler. Thus it is assumed that the high quality heat from the salt cooler can be recovered (e.g. by producing steam) and efficiently utilized.

The cryogenic unit does not require any thermal energy and is marked zero in FIG. 8B. The net thermal energy depends on the difference in temperature between the absorber and desorber and does not depend significantly on the salt circulation rate or the mode of operation of the absorption/desorption cycle. The different salt circulation rates for the different operating conditions (TSA or PSA/TSA) impact the duties of both the salt heater (energy expended) and salt cooler (energy recovered), resulting in net specific thermal loads that are almost independent of the salt circulation rate.

### Total Energy Demand (Thermal Energy Equivalent)

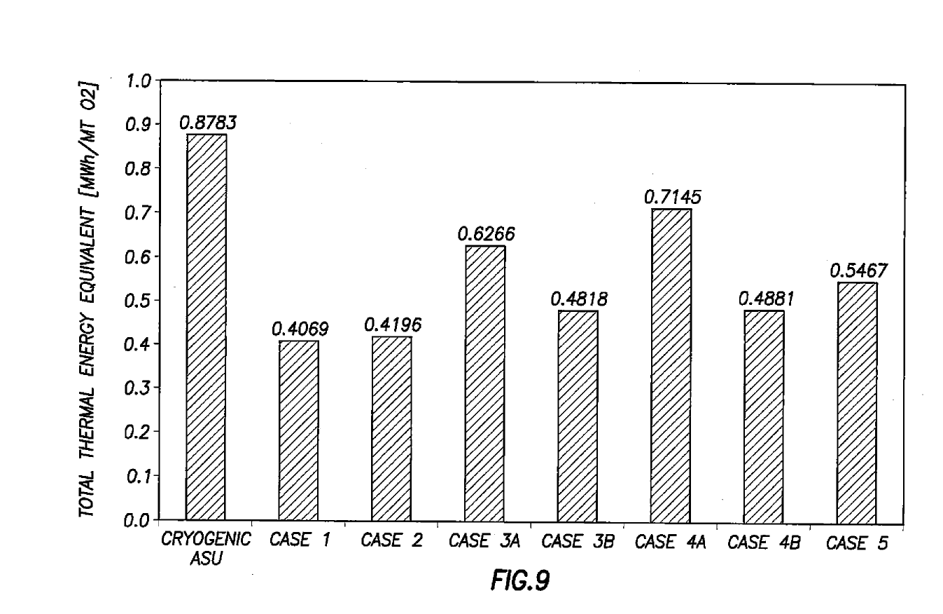

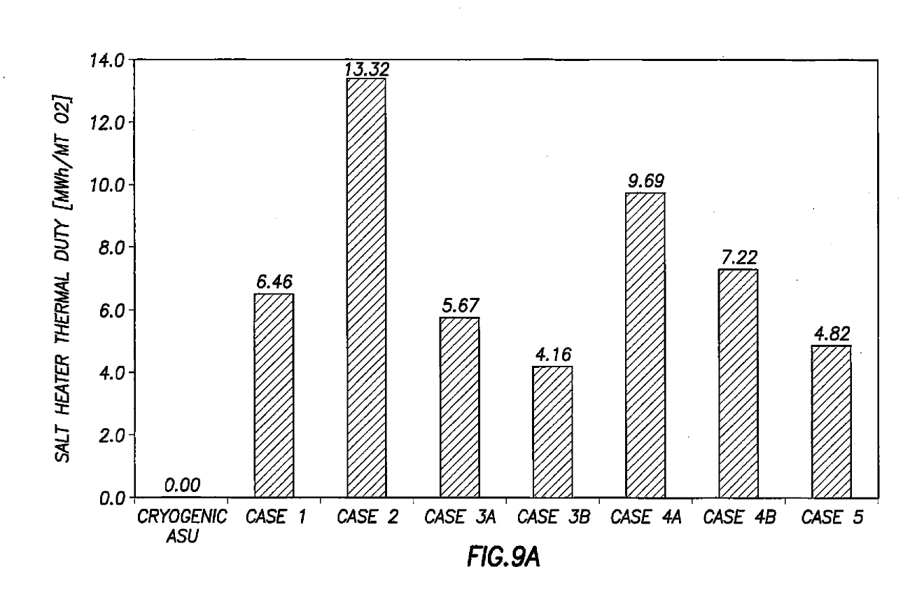

The total energy demands in terms of thermal energy equivalent for the different cases are presented in FIG. 9 and are compared with the cryogenic ASU. The thermal energy equivalents for the power necessary to run the processes are calculated assuming a thermal to mechanical energy conversion efficiency of 30%. As seen in FIG. 9, the energy requirements for the molten salt processes are significantly lower than the cryogenic ASU by 19-54%. The TSA cycles (1 and 2) have the lowest energy demands, followed by the PSA/TSA processes with low desorption pressure (3B, 4B and 5). The PSA/TSA cases with high absorption pressure (3A and 4A) have the highest energy requirements.

However, to optimize the system, FIG. 9 should be considered in conjunction with FIG. 9A, which shows the absolute thermal loads in the salt heater for all the cases examined. The salt heater duties are larger than the base case for the cases where the salt circulation is higher than the base case, and vice versa. When the salt heater load increases, the salt cooler duty will increase as well, thereby increasing the footprint of the process. Moreover, increase in the salt circulation may also increase the amount of dissolved nitrogen and argon (assumed insoluble in the current model and hence this effect has not been predicted), which may impact the purity of the oxygen being produced (Cassano, 1985). Thus, option 2, in spite of lower energy demand, is unlikely to be the optimum when the desorption temperature is 873K. This is because of the high salt circulation rate and heater thermal duty necessary under this condition.

Among the cases that run the desorber at high temperature of 921.9K (cases 1, 3A and 3B), the base case conditions seem to be the optimum. But if a further reduction in salt circulation rate is warranted, case 3B would be the optimum choice. The total energy demand for case 3B is 18% more than the base case, but the salt circulation rate and thermal duty in the salt heater are reduced by about 35%. On the other hand, among the cases that run the desorber at the lower temperature of 873K (cases 2, 4A, 4B and 5), cases 4B and 5 seem to be the better options. The total energy demand for case 4B is 20% more than the base case, and the salt circulation rate and thermal duty in the salt heater are increased by about 50% and 12% respectively. In case 5, the energy demand increases by 34% while the salt circulation rate is same as in the base case; the salt heater load decreases by about 25% because of the lower temperature of desorption.

### Qualitative Comparison Among the Various Cases

A qualitative comparison among the different molten salt cases investigated in this study is compiled in Table I. The variations in the operating parameters for the seven cases and their probable impacts on the equipments involved in the process are outlined—the effects that are explicitly understood from this modeling study have been stated quantitatively while others are mentioned in a qualitative sense. The base case (case 1) is taken as the benchmark for comparison purposes and all impacts mentioned in Table I are relative to the base case scenario.

TABLE 1
Qualitative comparison among the seven oxygen generation cases with molten salt

| | | MOC | | | | |
|---|---|---|---|---|---|---|
| Case | Key Process | Desired | Salt | | | Salt |
| No. | Details | Feature | Flow | Absorber | Desorber | Heater |
| 1 | TSA; Desorber | Withstand salt | Base | Base case | Base case | Base case |
| | at 649° C. | corrosion at | case | (atmospheric | (atmospheric | |
| | | 649° C. | | pressure) | pressure) | |
| 2 | TSA; Desorber | Withstand salt | Increase | Larger than base | Larger than base | Duty |
| | at 600° C. | corrosion at | by | case (high salt | case (high salt | increase by |
| | | 600° C. | 175% | flow) | flow) | 106% |
| 3A | PSA/TSA; | Withstand salt | Reduced | Smaller than | Similar to base | Duty |
| | Absorber at 4 atm.; | corrosion at | by 12% | base case (high | case | reduced by |
| | Desorber | 649° C. | | pressure) | | 12% |
| | at 649° C. | | | | | |
| 3B | PSA/TSA; | Withstand salt | Reduced | Similar to base | Larger than base | Duty |
| | Desorber at 0.5 atm.; | corrosion at | by 35% | case | case (low pressure) | reduced by |
| | Desorber | 649° C. | | (atmospheric | | 36% |
| | at 649° C. | | | pressure) | | |
| 4A | PSA/TSA; | Withstand salt | Increase | Unknown (high | Larger than base | Duty |
| | Absorber at 4 atm.; | corrosion at | by | pressure but high | case (high salt | increase by |
| | Desorber | 600° C. | 100% | salt flow) | flow) | 50% |
| | at 600° C. | | | | | |
| 4B | PSA/TSA; | Withstand salt | Increase | Larger than base | Larger than base | Duty |
| | Desorber at 0.5 atm.; | corrosion at | by 50% | case (high salt | case (low pressure | increase by |
| | Desorber | 600° C. | | flow) | and high salt flow) | 12% |
| | at 600° C. | | | | | |
| 5 | PSA/TSA; | Withstand salt | Similar | Similar to base | Larger than base | Duty |
| | Desorber at | corrosion at | to base | case | case (low pressure) | reduced by |
| | 0.27 atm.; | 600° C. | case | (atmospheric | | 25% |
| | Desorber at | | | pressure) | | |
| | 600° C. | | | | | |

| Case | Key Process | | | | | Energy |
|---|---|---|---|---|---|---|
| No. | Details | Salt Cooler | Pump | Compressors | Expander | Demand |
| 1 | TSA; Desorber | Base case | Base case | Base case air | None | Base case |
| | at 649° C. | | | compressor | | |
| 2 | TSA; Desorber | Duty increase | Highest | Air compressor | None | Increased |
| | at 600° C. | by 108% | capacity | similar to base case | | by 3% |
| 3A | PSA/TSA; | Duty reduced | Lower | Air compressor | Added | Increased |
| | Absorber at 4 atm.; | by 12% | capacity | larger than base | | by 54% |
| | Desorber | | but high | case (more stages | | |
| | at 649° C. | | compression | for higher | | |
| | | | | compression) | | |
| 3B | PSA/TSA; | Duty reduced | Lower | Air compressor | None | Increased |
| | Desorber at 0.5 atm.; | by 36% | capacity | similar to base case; | | by 18% |
| | Desorber | | but high | vacuum compressor | | |
| | at 649° C. | | compression | for oxygen | | |
| 4A | PSA/TSA; | Duty increase | Higher | Air compressor | Added | Increased |
| | Absorber at 4 atm.; | by 51% | capacity | larger than base | | by 76% |
| | Desorber | | and high | case (more stages | | |
| | at 600° C. | | compression | for higher | | |
| | | | | compression) | | |
| 4B | PSA/TSA; | Duty increase | Higher | Air compressor | None | Increased |
| | Desorber at 0.5 atm.; | by 12% | capacity | similar to base case; | | by 20% |
| | Desorber | | and high | vacuum compressor | | |
| | at 600° C. | | compression | for oxygen | | |
| 5 | PSA/TSA; | Duty reduced | Similar | Air compressor | None | Increased |
| | Desorber at | by 25% | capacity | similar to base case; | | by 34% |
| | 0.27 atm.; | | as base | vacuum compressor | | |
| | Desorber at | | case but | for oxygen | | |
| | 600° C. | | high | | | |
| | | | compression | | | |

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations and equivalents are considered within the scope and spirit of the present invention. Also, the terms in the claims have their plain, ordinary meaning unless otherwise explicitly and clearly defined by the patentee.

### REFERENCES

1. Simpson, A. P. and Simon, A. J., Second law comparison of oxy-fuel combustion and post-combustion carbon dioxide separation, Energy Conversion and Management, 2007, 48, 3034-3045.
2. Dunbobbin, B. R. and Brown, W. R., Pilot plant development of a chemical air separation process: report of period 1 Oct. 1984-30 Sep. 1986, DOE Report for contract #AC07-82CE40544, 1987.
3. Kang, D., Wong, K. P., Archer, R. A. and Cassano, A. A., Corrosion study in the chemical air separation (MOLTOX™) process, DOE report for contract #DE-FC07-87M12672, 1988.
4. Archer, R. A. and Dunbobbin, B. R., Pilot plant development of a chemical air separation process: interim report, 1 Oct. 1982-30 Sep. 1984, DOE Report for contract #AC07-82CE40544, 1985.
5. Yaws handbook of thermodynamic properties of hydrocarbons and chemicals.
6. Iwadate, Y., Okada, I. and Kawamura, K., Density and heat capacity of molten NaNO₂—KNO₃ mixtures, Journal of Chemical Engineering Data, 27, 288-290, 1982.
7. Erickson, D. C., Oxygen production by molten alkali metal salts, U.S. Pat. No. 4,340,578 (1982).
8. Cassano, A. A., Oxygen production by molten alkali metal salts using multiple absorption-desorption cycles, U.S. Pat. No. 4,526,775 (1985).

What is claimed is:

1. A continuous method for producing oxygen comprising the steps of:
providing an absorber wherein the absorber is configured to accept an absorber feed, a gas mixture, and wherein the absorber is configured to provide an absorber bottoms and an absorber overheads;
providing a desorber wherein the desorber is configured to accept a desorber feed and wherein the desorber is configured to provide a desorber bottoms and a desorber overheads;
wherein the absorber bottoms is in fluid communication with the desorber feed and wherein the desorber bottoms is in fluid communication with the absorber feed;
providing a molten salt mixture wherein the molten salt mixture comprises a catalytic agent and one of a metal nitrate salt and a metal nitrite salt, and;
circulating the molten salt mixture in a continuous circulation loop through the absorber and the desorber;
maintaining the desorber at a desorber temperature and a desorber pressure wherein the absorber temperature is less than the desorber temperature wherein the desorber temperature is from about 450° C. to about 605° C.;
maintaining the absorber at an absorber temperature and an absorber pressure wherein the absorber pressure is greater than the desorber pressure wherein the desorber pressure is from about 0.1 atm to about 0.5 atm;
introducing a gas mixture into the absorber by way of the gas mixture wherein the gas mixture comprises oxygen;
allowing the oxygen in the gas mixture to react by way of an oxidation reaction with the nitrite salts in the molten salt mixture to form nitrate salts in the absorber; and
allowing the nitrate salts in the desorber to react by way of a decomposition reaction to form nitrite salts so as to release oxygen in the desorber and allowing the oxygen to exit the desorber by way of the desorber overheads.

2. The method of claim 1 wherein the desorber temperature is from about 580° C. to about 605° C.

3. The method of claim 1 wherein the desorber pressure is from about 0.1 atm to about 0.5 atm.

4. The method of claim 1 further comprising the step of increasing the salt circulation rate to achieve an oxygen recovery rate of at least about 95%.

5. The method of claim 1 further comprising the step of increasing the salt circulation rate to achieve an oxygen recovery rate of at least about 99%.

6. The method of claim 1 wherein the gas mixture is air and wherein the method further comprises the step of heating the gas mixture prior to the step of introducing the gas mixture into the absorber.

7. The method of claim 1 wherein the molten salt mixture has from about 74% to about 99% of metal nitrate salt, from about 1% to about 26% metal nitrite salt, and from about 1% to about 3% catalytic agent.

8. The method of claim 1 wherein the catalytic agent is a peroxide, a superoxide, a metal oxide, or any combination thereof.

9. The method of claim 1 wherein the metal nitrate salt comprises an alkali metal nitrate, wherein the alkali metal is potassium, sodium, or any combination thereof.

10. The method of claim 1 wherein the molten salt mixture comprises a metal nitrate salt and a metal nitrite salt.

11. The method of claim 1 wherein the absorber is a multi-stage countercurrent tower or a packed column and wherein the continuous circulation loop is a molten salt mixture fluid pathway comprising the absorbers bottoms in direct or indirect fluid communication with the desorber feed and the desorber bottoms in direct or indirect fluid communication with the absorber feed.

12. The method of claim 1 further comprising the step of providing a salt heater and a salt cooler, wherein the salt heater heats the molten salt mixture from the absorber bottoms before the molten salt mixture enters the desorber and wherein the salt cooler cools the molten salt mixture from the desorber bottoms before the molten salt mixture enters the absorber feed.

13. The method of claim 12 wherein the salt cooler converts water to steam by way of an indirect heat exchange of the water with the molten salt mixture passing through the salt cooler.

14. The method of claim 13 further comprising the step of supplying the steam to an external process

15. The method of claim 14 wherein the external process comprises a SAGD process for extracting heavy oil from a bitumen reservoir.

16. The method of claim 1 wherein the molten salt mixture further comprises an oxygen scavenger wherein the oxygen scavenger is Cu—Cu₂O, Cu₂O—CuO, FeO—Fe₃O₄ Fe₃O₄—Fe₂O₃, Ni—NiO, Co—COO, CoO—Co₃O₄, MnO—Mn₃O₄, Mn₃O₄—Mn₂O₃, MoO₂—MoO₃, V₈O₁₅—VO₂, VO₂—V₂O₅, Sb—Sb₂O₃, Cr₂O₃—CrO₂, Pb—PbO, Bi—Bi₂O₃, or combinations thereof.

17. The method of claim 1 further comprising the step of introducing a stripping gas in the desorber to enhance oxygen removal from the molten salt.

18. The method of claim 1 wherein the absorber, the desorber, and the absorber bottoms, and the desorber bottoms are substantially formed of a metallurgy that is not substantially susceptible to corrosion from the molten salt mixture during the step of circulating the molten salt mixture.

19. The method of claim 18 wherein the metallurgy comprises a high-temperature alloy.

20. The method of claim 17 wherein the metallurgy comprises an austenitic nickel-chromium-based alloy.

21. The method of claim 2 further comprising the steps of:
increasing the salt circulation rate or decreasing the desorber pressure to achieve an oxygen recovery rate of at least about 95%;
providing a salt heater and a salt cooler, wherein the salt heater heats the molten salt mixture from the absorber bottoms before the molten salt mixture enters the desorber and wherein the salt cooler cools the molten salt mixture from the desorber bottoms before the molten salt mixture enters the absorber feed; wherein the salt cooler converts water to steam by way of an indirect heat exchange of the water with the molten salt mixture passing through the salt cooler.
supplying the steam to an external process, wherein the external process comprises a SAGD process for extracting heavy oil from a bitumen reservoir;
wherein the desorber pressure is from about 0.1 atm to about 0.5 atm;
wherein the gas mixture is air and wherein the method further comprises the step of heating the gas mixture prior to the step of introducing the gas mixture into the absorber;
wherein the molten salt mixture has from about 74% to about 99% of metal nitrate salt, from about 1 to about 26% metal nitrite salt, and from about 1% to about 3% catalytic agent;
wherein the absorber is a multi-stage countercurrent tower or a packed column and wherein the continuous circulation loop is a molten salt mixture fluid pathway comprising the absorber bottoms in direct or indirect fluid communication with the desorber feed and the desorber bottoms in direct or indirect fluid communication with the absorber feed; and
wherein the absorber, the desorber, and the absorber bottoms, and the desorber bottoms are substantially formed of a metallurgy that is not substantially susceptible to corrosion from the molten salt mixture during the step of circulating the molten salt mixture.

22. The method of claim 1 wherein the gas mixture is air and wherein the method further comprises the step of adjusting the molten salt circulation rate to about 4 to about 16 moles of molten salt mixture per mole of air fed to the absorber.

23. A continuous method for producing oxygen comprising the steps of:
providing an absorber wherein the absorber is configured to accept an absorber feed, a gas mixture, and wherein the absorber is configured to provide an absorber bottoms and an absorber overheads;
providing a desorber wherein the desorber is configured to accept a desorber feed and wherein the desorber is configured to provide a desorber bottoms and a desorber overheads;
wherein the absorber bottoms is in fluid communication with the desorber feed and wherein the desorber bottoms is in fluid communication with the absorber feed;
providing a molten salt mixture wherein the molten salt mixture comprises a catalytic agent and one of a metal nitrate salt and a metal nitrite salt;
circulating the molten salt mixture in a continuous circulation loop through the absorber and the desorber;
maintaining the desorber at a desorber temperature and a desorber pressure wherein the absorber temperature is less than the desorber temperature wherein the desorber temperature is from about 300° C. to about 630° C.;
maintaining the absorber at an absorber temperature and an absorber pressure wherein the absorber pressure is greater than the desorber pressure wherein the desorber pressure is from about 0.1 atm to about 0.5 atm;
introducing a gas mixture into the absorber by way of the gas mixture wherein the gas mixture comprises oxygen;
allowing the oxygen in the gas mixture to react by way of an oxidation reaction with the nitrite salts in the molten salt mixture to form nitrate salts in the absorber; and
allowing the nitrate salts in the desorber to react by way of a decomposition reaction to form nitrite salts so as to release oxygen in the desorber and allowing the oxygen to exit the desorber by way of the desorber overheads.
